(19) United States
(12) Patent Application Publication
(10) Pub. No.: US 2018/0194270 A1
(43) Pub. Date: Jul. 12, 2018

(54) A SPACER

(71) Applicant: Bopworx Limited, Lisnaskea (GB)

(72) Inventors: Paul Gerard McGriskin, Lisnaskea (GB); Ciara Anne McGriskin, Lisnaskea (GB); Cian Desmond O'Sullivan, Limerick (IE)

(21) Appl. No.: 15/105,928

(22) PCT Filed: Dec. 17, 2014
(86) PCT No.: PCT/GB2014/000517

§ 371 Date: Jun. 17, 2016

(30) Foreign Application Priority Data
Dec. 18, 2013 (GB) 1322367.2

(51) Int. Cl. B60P 7/135; B62J 23/00; F16M 13/02; B65D 81/05

(52) U.S. Cl. CPC B60P 7/135; B62J 23/00; B62H 3/02; B65D 81/05; F16M 13/022

(57) ABSTRACT

A spacer for spacing apart two attached articles, particularly for spacing apart bicycles from each other or other articles such as racks to protect the articles comprising a spacer body and engaging means on the spacer body for reversibly attaching the spacer to a first article to prevent impact with a second article, the spacer body being solid or rotatable to correctly orient the spacer and the attached articles.

### FIELD OF THE INVENTION

This invention relates to a spacer for spacing apart articles such as bicycles and to a spacer system incorporating the spacer.

### BACKGROUND OF THE INVENTION

Articles to be transported, stored or packaged must frequently be spaced apart from their surroundings or adjacent similar/different articles in order to prevent damage to the articles or the surroundings. This is particularly the case with expensive profiled articles such as bicycles, bicycle racks, bicycle holders and the like.

For example, when transporting or storing bicycles on bicycle racks it is common practice to mount multiple bicycles on the racks so that the bicycle frames abut each other which can result in costly and unsightly impact damage to the frames.

More particularly, mounting bicycles directly onto or against a rack can sometimes result in damage to the bicycles and/or to the rack as a result of contact friction or impact between the bicycles and between the bicycles and the rack. In addition, when a bicycle is mounted on a rack fixed to a vehicle, movement of the vehicle over uneven surfaces can impart vibrations to the rack resulting in increased contact friction between the bicycles and the bicycles and the rack.

To reduce such damage, it is known to place soft materials such as foam, rubber or neoprene between the bicycle frames and the rack. However, such materials must generally be adhered to the frames and racks leaving unsightly residues whilst the materials can become worn or damaged following repeated use thus exposing the frames and racks resulting in damage. In addition, the racks can include straps to tether bicycles to the rack to prevent frictional movement. However, straps too can become worn and break following repeated use.

It would therefore be desirable to provide a device that mitigates the problems outlined above and which can advantageously prevent direct contact between articles and in particularly profiled articles such as bicycles and bicycle racks by spacing the articles apart to prevent damage to the articles.

In the following description spacers of the invention are principally described having regard to bicycles and bicycle racks for convenience. However, as will be appreciated by those skilled in the art, the invention should not be construed as being limited to spacers for use solely with bicycles but has application with a range of profiled and non-profiled articles.

### SUMMARY OF THE INVENTION

According to the invention there is provided a spacer for spacing apart articles comprising:
a spacer body, and
engaging means on the spacer body for reversibly attaching the spacer to a first article to prevent impact with a second article.

Preferably, the engaging means is reversibly attachable to the first and second articles. More preferably, the engaging means comprises selectable engaging means to orientate the spacer on the article.

Suitably, the spacer body comprises a solid spacer body.

Preferably, the spacer body comprises a rotatable spacer body. More preferably, the rotatable spacer body comprises a two-part rotatable body and the first part is rotatable with respect to the second part.

Advantageously, the spacer body comprises a central bore. Preferably, the central bore comprises a threaded central bore.

Preferably, the engaging means comprises a slot on the spacer body. More preferably, the slot comprises a peripheral slot on the spacer body. Most preferably, the slot comprises an indent.

Suitably, the slot comprises a bar on the spacer body.

Alternatively, the engaging means comprises a stud on the spacer body. Preferably, the stud comprises a peripheral stud on the spacer body.

Preferably, the spacer comprises at least two opposite engaging means. More preferably, the spacer comprises at least four engaging means. Optionally, the spacer comprises at least six engaging means.

Preferably, the spacer comprises a securing means for securing the engaging means to an article. More preferably, the securing means comprises a strap. Most preferably, the strap comprises an adjustable strap.

Suitably, the adjustable strap comprises an elasticated strap. Alternatively, the strap so comprises a belt-like strap.

In a preferred embodiment of the invention, the spacer comprises a bicycle spacer.

The invention also extends to the use of a spacer as hereinbefore defined to separate bicycles.

In a further embodiment, the invention also extends to a spacer system comprising at least two spacers as hereinbefore defined.

Accordingly, in one aspect, the invention provides a spacer block for spacing apart two articles and comprises at least one securing means for securing the spacer block to the articles. The spacer block is particularly useful in spacing a bicycle from a rack, wherein said spacer block is locatable between the bicycle and the rack and comprises at least one securing means for securing the spacer block to the bicycle and/or rack.

Optionally the spacer block further comprises at least one engaging means for releasably engaging the securing means.

Optionally the securing means comprises at least one strap for releasably securing the spacer block to the bicycle and/or rack. Optionally the strap is configured to releasably engage the engaging means on the spacer block.

Optionally the strap comprises a hook engageable with the engaging means on the spacer block. Optionally, or additionally, the strap comprises a stop engageable with the engaging means on the spacer block. Optionally the engaging means comprises a slot on the spacer block.

Optionally, or additionally, the strap comprises at least one aperture engageable with the engaging means on the spacer block. Optionally the engaging means comprises a stud. Optionally the aperture is configured to receive the stud. Further optionally, the aperture is configured to releasably retain the stud. Optionally the stud comprises at least one neck portion and one head portion. Optionally the stud has a T-shaped configuration in longitudinal cross-section.

Optionally the spacer block is formed of a cushioning material. Alternatively, the spacer block is formed in part of a cushioning material. Optionally the cushioning material is rubber. Optionally the cushioning material is located on at least part of the surface of the spacer block. Further optionally, the cushioning material is a pad located on at least part of the surface of the spacer block.

Optionally the spacer block comprises at least two bodies configured to reversibly interlock. Further optionally the spacer block comprises at least two bodies, each body configured to reversibly interlock with a further body.

In a second aspect, the invention provides a spacer block system comprising at least one spacer block of the first aspect of the invention, wherein the spacer block comprises at least two bodies configured to reversibly interlock.

In a third aspect, the invention provides a kit comprising at least one spacer block of the first aspect of the invention or at least one spacer block system of the second aspect of the invention, and instructions for use.

The spacer of the invention effectively prevents impact damage to articles such as profiled articles including bicycle components such as frames, handlebars, forks and the like by creating and maintaining a distance between adjacent articles.

The spacer of the invention is also suitable for use with articles having a wide range of shapes and cross-sections while more than one spacer can be used in combinations (e.g. by joining two or more spacers) to increase the space between articles as required. Individual spacers can also be linked by securing means such as straps to create webs or networks of spacers to protect large articles of different shapes and sizes such as cases, panels and the like. Moreover, the two-part rotatable spacer of the invention allows spaced-apart articles to be oriented as required to minimise the risk of damage between the articles.

The spacers of the invention can also be dimensioned as required in accordance with the desired end use i.e. the spacers of the invention can be manufactured in any sizes as required whilst maintaining functionality so that the spacers can be used with small to extremely large objects.

The spacer of the invention can also be used with a range of securing means in the form of straps which can also be varied in size and function as required e.g. elasticated or stretchable (“bungees”) and size-adjustable straps.

The generally V-shaped recess employed in the spacer is adapted to receive articles having a range of shapes and sizes so that smaller articles are recessed or received further into the recess for secure attachment to the spacer.

As indicated above, the spacers of the invention are particularly suitable for use with bicycles and bicycle components to protect bicycles from damage during transport and storage. The spacer is particularly adapted for spacing apart articles at different angles through the use of multiple securing and engaging means that can be oriented at multiple angles and or thorough the use of a rotatable spacer body that can be rotated as required to orient articles to which the spacer is attached.

The spacer of the invention is also easy to use in confined spaces and is reusable.

### BRIEF DESCRIPTION OF THE DRAWINGS

Embodiments of the invention will now be described, by way of example only, with reference to the accompanying drawings in which:

FIG. 1 is a perspective view from above and one side of a first embodiment of a spacer of the invention;

FIG. 2 is a plan view from above of the spacer of FIG. 1;

FIG. 3 is a perspective view from above and one side of the spacer together with the securing means in the form of a strap for attaching the spacer to an article;

FIG. 4 is a perspective view from above and one side of the spacer secured between two profiled cylindrical articles such as the tubes of two bicycle frames by securing means in the form of two straps;

FIG. 5 is a perspective view from above and one side of the spacer system of the invention made up of two spacers of FIG. 1 configured to reversibly interlock and secured between the two cylindrical articles of FIG. 4 by securing means in the form of two straps;

FIG. 6 is a sequential perspective view from above and one side of the spacer of FIG. 1 being fitted with securing means in the form of a hook and strap at the engaging means in the form of a slot on the spacer;

FIG. 7 is an enlarged perspective view from above and one side of the hook and strap of FIG. 6;

FIG. 8 is a perspective view from above and one side of a second embodiment of the spacer of the invention in which the spacer is substantially circular or disc-shaped and has four recessed engaging means in the form of slots;

FIG. 9 is an exploded perspective view from above and one side of the spacer of FIG. 8;

FIG. 10 is an enlarged perspective view from above and one side of the strap for use with the spacer of FIG. 8;

FIG. 11 is a top plan view of the spacer;

FIG. 12 is a side elevation of the spacer;

FIG. 13 is a side elevation of a bicycle fitted with a plurality of the spacers of FIGS. 8 to 12 on the bicycle frame, fork and handlebar;

FIG. 14 is a perspective view from above and one side of the bicycle fitted with the spacer of FIGS. 8 to 12 on the top tube of the bicycle frame to protect the frame from damage by an article in the form of a column against which the bicycle is placed;

FIG. 15 is a side elevation of the bicycle and column of FIG. 14;

FIG. 16 is a front plan view of the bicycle of FIG. 14;

FIG. 17 is a perspective view from above and one side of a second embodiment of the spacer system of the invention made up of a plurality of the spacers of FIG. 8 interconnected by elasticated straps with hooks;

FIG. 18 is a top plan view of the spacer system of FIG. 17;

FIG. 19 is a side elevation of the spacer system;

FIG. 20 is an enlarged side elevation of a single spacer and associated elasticated straps and hooks of the spacer system;

FIG. 21 is a perspective view from above and one side of the spacer system of FIG. 17 fitted to a package such as a case to space the case from articles and protect the case from damage when coming into contact with other articles such as hard surfaces or other cases;

FIG. 22 is a top plan view of the case and spacer system of FIG. 21;

FIG. 23 is an end elevation of the case and spacer system;

FIG. 24 is a perspective view from above and one side of a third embodiment of the spacer system of the invention made up of a plurality of the spacers of FIG. 8 interconnected by length adjustable straps with hooks;

FIG. 25 is a top plan view of the spacer system of FIG. 24;

FIG. 26 is a side elevation of the spacer system;

FIG. 27 is an enlarged side elevation of a single spacer and associated elasticated straps and hooks of the spacer system;

FIG. 28 is a perspective view from above and one side of the spacer system of FIG. 24 fitted to a flat package, e.g. a glass panel, to space the package from other articles and protect the package from damage when coming into contact with other articles or surfaces;

FIG. 29 is a plan view from above of the spacer system and package of FIG. 28;

FIG. 30 is a perspective view from above and one side of a third embodiment of the spacer of the invention in which the spacer is provided with a centrally located internal thread for attachment to other spacers or accessories;

FIG. 31 is a top plan view of the spacer of FIG. 30;

FIG. 32 is a side elevation of the spacer;

FIG. 33 is a longitudinal cross-section of the spacer along the line XXXIII-XXXIII of FIG. 32;

FIG. 34 is a perspective view from above and one side of a fourth embodiment of a spacer fitted with two straps in which the spacer is a rotatable spacer made up of a two-part body in which the two parts are rotatable with respect to each other in the directions indicated by the arrows to allow transverse positioning of elongate articles between which the spacer is secured;

FIG. 35 is a side elevation of the spacer of FIG. 34;

FIG. 36 is a partially exploded perspective view from above and one side of the straps and hooks of the spacer;

FIG. 37 is an exploded perspective view from above and one side of the spacer with the two rotatable parts separated to show the internal components of the spacer;

FIG. 38 is a longitudinal cross-section through the two-part spacer of FIG. 34;

FIG. 39 is a perspective view from above and one side of the two-part rotatable spacer of FIG. 34 in use mounted between the top tubes of two bicycle frames to keep the bicycle frames apart during transport and/or storage with the top tubes in a transverse orientation with respect to each other;

FIG. 40 is a side elevation of the spacer and top tubes of FIG. 39;

FIG. 41 is a perspective view from above and one side of the two-part spacer of FIG. 34 mounted between two cylindrical articles disposed at right angles to each other, and

FIG. 42 is a top plan view of the spacer and cylindrical articles of FIG. 41.

### DESCRIPTION OF PREFERRED EMBODIMENTS

The present invention provides a spacer block 1 for spacing apart two articles. For the purposes of clearly disclosing the present embodiment of the invention, the spacer block 1 will be described in respect of spacing a bicycle from a rack to reduce or prevent damage to the rack or to the bicycle, in particular to the frame of the bicycle, which may occur when the bicycle is mounted on or against a rack. It will be appreciated, however, that the spacer block 1, spacer block system and kit of the invention described in detail below are suitable for maintaining a gap between any articles where such a gap is necessary or desired.

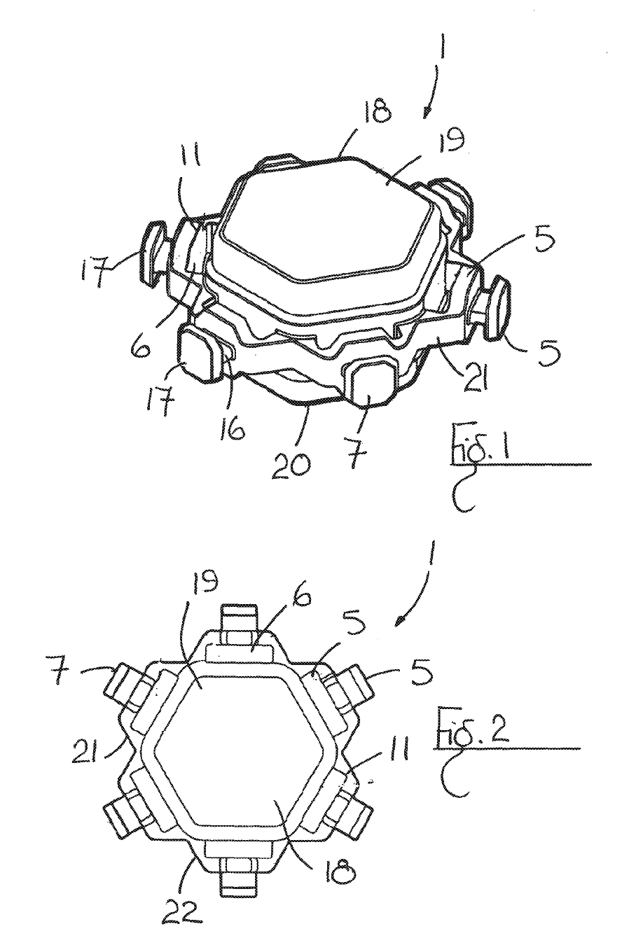

Referring to FIGS. 1 to 6, the spacer block 1 of the invention comprises at least one securing means 4 for releasably securing the spacer block 1 to one or more articles 2,3 such as a bicycle and/or rack. The securing means 4 may be configured to engage the spacer block 1 and to secure the spacer block 1 to an article 2,3. The spacer block 1 may comprise a plurality of securing means 4, for example 1, 2, 3, 4, 5, 6, 7, 8, 9, 10, 11, 12, 13, 14, 15, 16, 17, 18, 19, 20 or more securing means 4.

The spacer block 1 may further comprise at least one engaging means 5 for releasably engaging the securing means 4. Thus the spacer block 1 may comprise a plurality of equally spaced apart engaging means 5, for example 1, 2, 3, 4, 5, 6, 7, 8, 9, 10, 11, 12, 13, 14, 15, 16, 17, 18, 19, 20 or more engaging means 5 each capable of engaging at least one securing means 4. As described further below, the engaging means 5 may comprise a slot 6 or a stud 7.

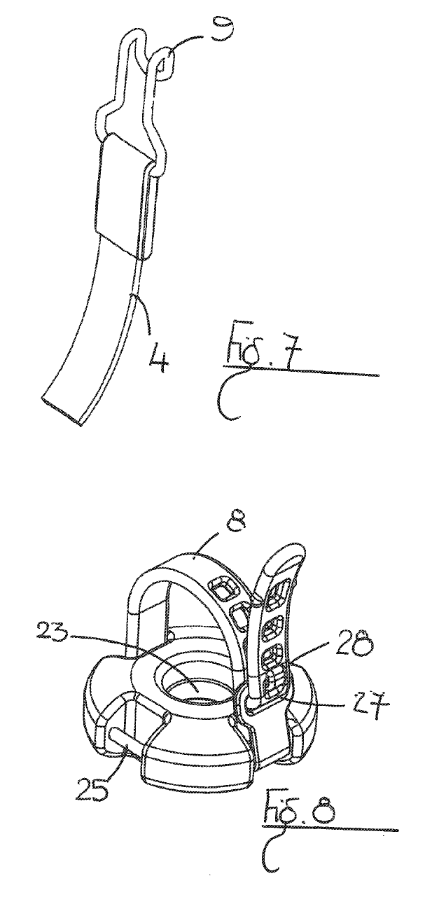

The securing means 4 may take any suitable form and may be, for example, a strap 8. The spacer block 1 may comprise at least one strap 8 for releasably securing the spacer block 1 to a bicycle and/or rack. The strap 8 may be configured to releasably engage an engaging means 5 on the spacer block 1. Thus, the strap 8 may comprise a hook 9 engageable with the engaging means 5 on the spacer block 1. As indicated above, the engaging means 5 comprises a slot 6. The slot 6 may be configured to receive and releasably retain the hook 9. The strap 8 may comprise a hook 9 at one or both respective ends of the strap 8 (see FIG. 7). The strap 8 may comprise a hook 9 at one end of the strap 8 and the other end of the strap 8 may be configured to engage the same spacer block 1 or another spacer block 1, or another article 2,3 by any suitable means, for example, a second hook 9.

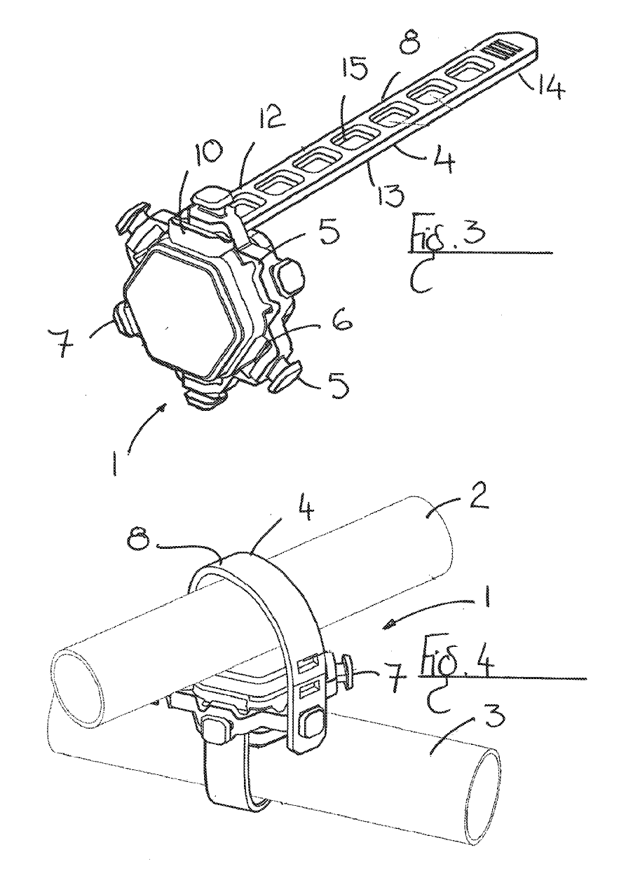

Alternatively, or additionally, the strap 8 may comprise a stop 10 engageable with the engaging means 5 on the spacer block 1. As noted above, in one embodiment, the engaging means 5 may comprise a slot 6. The slot 6 may be configured to allow a strap 8 to pass through the slot 6 and to abut the stop 10 of the strap 8. The stop 10 may be formed of a portion of the strap 8 which is enlarged relative to the rest of the strap 8. By “enlarged” it is intended to mean that the cross-sectional diameter of the stop 10 is greater than the corresponding diameter of the strap 8. Thus, in use, a strap 8 may be passed through a slot 6 and a stop 10 may be arranged to inhibit passage of the whole strap 8 through the slot 6. The stop 10 may be suitably sized to abut at least part of the rim 11 of the slot 6 thereby releasably retaining the strap 8 in engagement with the spacer block 1. As illustrated in FIG. 3, a strap 8 may comprise a first end 12, a body 13 and a second end 14. The stop 10 may be located at the first end 12 of the strap 8. The body 13 of the strap 8 and the second end 14 of the strap 8 may be suitably sized to pass through the slot 6 on the spacer block 1 but the stop 10 is sized so as to abut about the rim 11 of the slot 6 and thus acts as a retaining “stop” 10 to maintain the strap 8 in releasable engagement with the spacer block 1.

In a particularly advantageous embodiment, the slot 6 on the spacer block 1 is configured to releasably engage both a hook 9 and a stop 10. Engagement of the hook 9 and the stop 10 with the slot 6 may be simultaneous, or may be non-simultaneous.

Alternatively, or additionally, the strap 8 may comprise one or more apertures 15, each aperture 15 suitable for receiving an engaging means 5 on the spacer block 1, for example, a stud 7 (see, for example, FIG. 4). The stud 7 may comprise at least one neck 16 and one head portion 17. The neck portion 16 of the stud 7 may be attached directly to the spacer block 1. Alternatively, the neck portion 16 may be attached to the rim 11 of a slot 6 on the spacer block 1. In an advantageous embodiment, the stud 7 may be T-shaped in longitudinal cross-section. A T-shaped stud 7 may comprise a neck portion 16 which projects substantially perpendicularly relative to the plane of the surface of the spacer block 1 to which it is attached. The T-shaped stud 7 further comprises a head portion 17 located at the end of the neck portion 16 distal to the surface of the spacer block 1. The head portion 17 may be larger in size relative to the neck portion 16. For example, the circumference of the head portion 17 may be greater than the circumference of the neck portion 16. Thus the head portion 17 may be suitably sized to allow part or all of the stud 7, including the head portion 17, to be received by the aperture 15 of a strap 8 and to engage about the aperture 15 to retain the strap 8 in releasable engagement with the spacer block 1.

In an alternative embodiment, the first end of a strap 12 may be integrally formed with the spacer block 1 and thus at least one end of the strap may be permanently attached to the spacer block 1.

In a particular embodiment of the invention, such as illustrated in FIGS. 1 to 3, the spacer block 1 may comprise a body 18 having a top wall or surface 19 and a bottom wall or surface 20 separated by a sidewall or surface 21. The spacer block 1 may comprise at least one engaging means 5 on the side surface 21 of the spacer block 1. The side surface 21 may further comprise a plurality of substantially flat faces 22. The number of faces 22 is not particularly limited and may be 1, 2, 3, 4, 5, 6, 7, 8, 9, 10 or more. The side surface 21 of the spacer block 1 may, for example, comprise six faces 22 and thus the spacer block 1 may have a substantially hexagonal configuration.

The spacer block 1 may be formed of any suitable material. For example, the spacer block 1 may be formed wholly or partly of a hard plastics material and/or a cushioning material. Advantageously, the spacer block 1 may be formed of a hard plastics material and further comprise a cushioning material on at least part of its surface. The spacer block 1 therefore acts to cushion any contact between the spacer block 1 and any article 2,3 to which it is secured, and to cushion any contact or impact between two articles 2,3 between which the spacer block 1 is placed. The cushioning material may be any suitable material, such as rubber. In a particular embodiment, a spacer block 1 of the invention may comprise the cushioning material on its top and bottom surfaces 19,20 respectively. The side surface 21, the slots 6 and/or the studs 7 on the side surface 21 may comprise the same material as the body 18 of the spacer block 1 or may comprise different material. For example, if there is a substantial load strain on a strap 8 engaging a spacer block 1, it may be advantageous that the slots 6 and/or studs 7 comprise a suitably strong material to maintain engagement with the strap 8 without breaking or shearing.

The strap 8 may be comprised of any suitable material. Preferably the material is an elastic material and may be, for example, rubber or elasticated nylon. Hooks 9 comprised at one or both ends 12,14 of the strap 8 may be formed of a suitably strong material, such as metal, and may be powder coated.

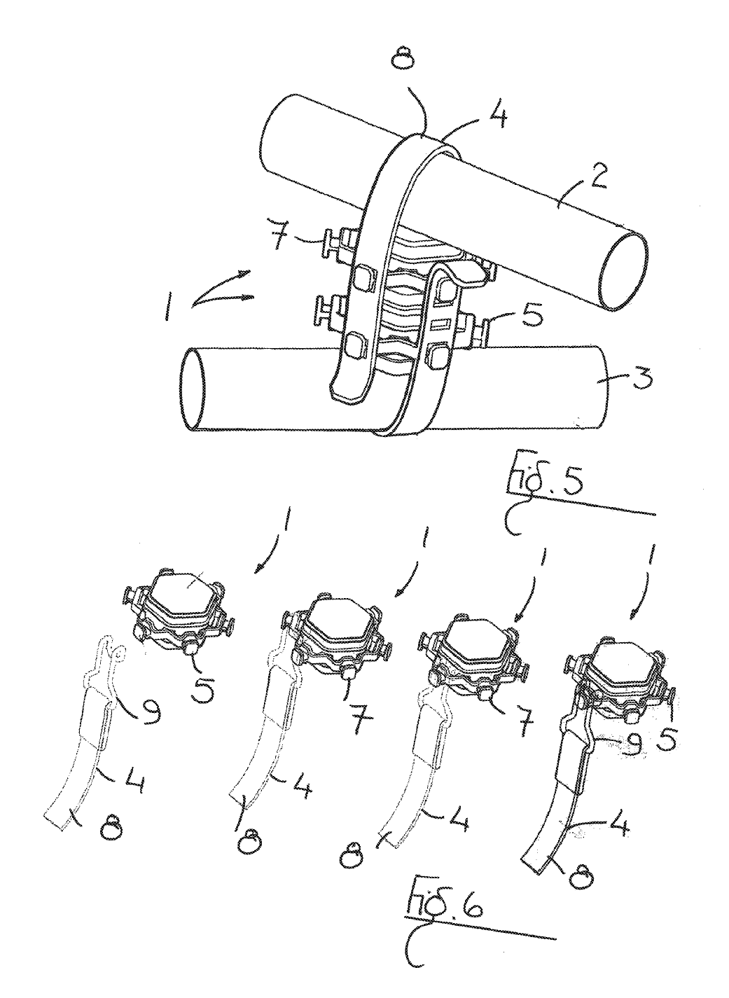

In use, when the first end 12 of a strap 8 is positioned to engage the spacer block 1, for example by means of a hook 9 ora stop 10, the body 13 and second end 14 of the strap 8 may be positioned circumferentially about an article 2,3 to which the spacer block 1 is to be secured (see FIG. 4). The body 13 or second end 14 of the strap 8 may then be manipulated to engage a slot 6 or a stud 7 on the spacer block 1 thus releasably securing the spacer block 1 to the article 2,3. One or more additional straps 8 may secure the spacer block 1 to a second article 2,3 in substantially the same manner as described for the first article 2,3 (see FIGS. 4 and 5). Thus, the spacer block 1 may be secured to the first and second articles 2,3 and maintain a space or gap between the articles 2,3 to prevent or reduce contact friction or damage caused by the articles 2,3 coming into contact with each other.

In an embodiment, a spacer block 1 of the invention may comprise a side surface 21 having multiple faces 22 each including an engaging means 5 such as a slot 6 and/or a stud 7 which allows a strap 8 to engage any one or more of the engaging means 5 on the spacer block 1. Thus, a spacer block 1 having a side surface 21 with multiple faces 22 can provide multiple engaging means 5 which are presented at different angles from the spacer block 1. In this configuration, one end 12 of a strap 8 may engage the spacer block 1 and the other end 14, once positioned around an article 2,3, may engage at any other face 22 on the side surface 21 of the spacer block 1 having a suitably angled engaging means 5 to provide secure attachment of the spacer block 1 to the article 2,3.

In a further embodiment, the spacer block 1 of the invention may comprise two or more bodies 18. The two or more bodies 18 may be configured in a side-by-side relationship. Advantageously, the two or more bodies 18 may be configured to reversibly interlock. The bodies 18 may reversibly interlock using any suitable means such as a reversible adhesive. Alternatively, the bodies 18 may comprise coupling means such as a tongue and groove arrangement, or a dovetailing arrangement, on the respective bodies 18. In an advantageous embodiment, the bodies 18 may interlock as a result of friction adhesion when the bodies 18 are placed side-by-side. The bodies 18 may thus be configured to form a stack of two or more bodies 18 and may be secured to an article 2,3 using one or more securing means, for example straps 8 as described above. The bodies 18 forming the spacer block 1 may be substantially similar in size and form, which thus allows for convenient stacking of the bodies 18. By “stacking” is meant at least one body 18 is placed or arranged on or against another body 18, optionally in a contiguous arrangement. The number of bodies 18 that may be stacked is not particularly limited and may be, for example, 2, 3, 4, 5, 6, 7, 8, 9, 10 or more. It will be understood that the number of bodies 18 to be stacked may be determined by the user based on the size of the space or gap to be maintained between two or more articles 2,3 by the spacer block 1. Each body 18 can comprise a spacer block 1 as described above herein.

A spacer block system of the second aspect of the invention comprises at least one spacer block 1 of the first aspect of the invention. The spacer block 1 can comprise at least two bodies 18 configured in a side-by-side relationship, each body 18 being a spacer block 1 as described above herein. Advantageously, the at least two bodies 18 may be configured to reversibly interlock. The spacer block system may further comprise securing means 4, for example at least one strap 8, for example, 1, 2, 3, 4, 5, 6, 7, 8, 9, 10 or more straps 8, configured to releasably engage the spacer block 1 as described above. As described above, each strap 8 may comprise a stop 10 engageable with a slot 6 of the spacer block 1 to act as a retaining stop 10. Alternatively, or in addition, each strap 8 may comprise a hook 9 engageable with a slot 6 of the spacer block 1. Alternatively, or in addition, each strap 8 may comprise at least one aperture 15 suitable for receiving a stud 7 comprised on the spacer block 1. Alternatively, one end 12 of each strap 8 may be integrally formed with a spacer block 1.

In another aspect, the invention provides a kit comprising at least one spacer block 1 of the invention. Each spacer block 1 can comprise at least two bodies 18 configured to reversibly interlock. Each body 18 can be a spacer block 1 as described above herein. The kit may be used to secure a spacer block 1 of the invention to one or more articles 2,3 thus preventing or reducing any contact friction or impact between articles 2,3. The kit may further comprise instructions for use.

In a further embodiment of the invention, the strap 8 of the spacer 1 can be a lockable strap 8 to prevent removal of the spacer 1 from bicycle. The lockable strap 8 could also serve to facilitate locking of the bicycle to a fixed article such as a post security purposes.

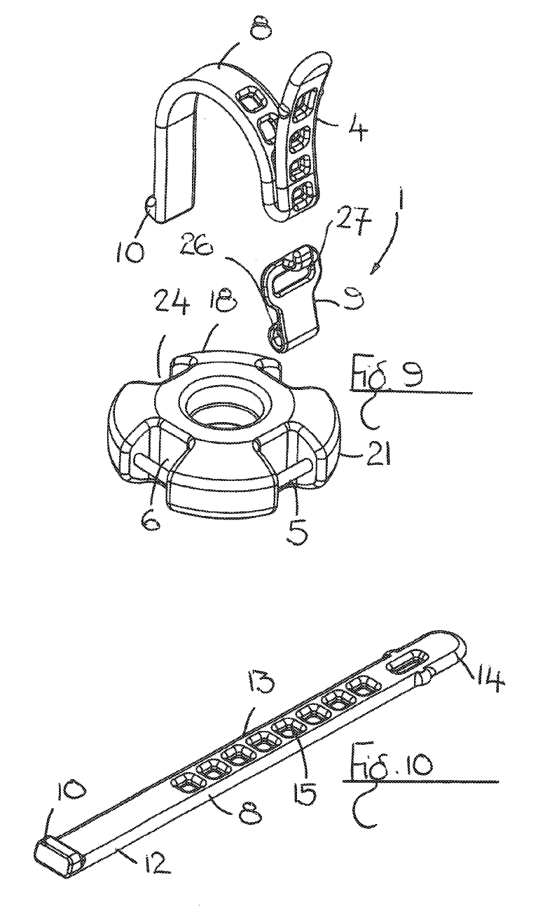

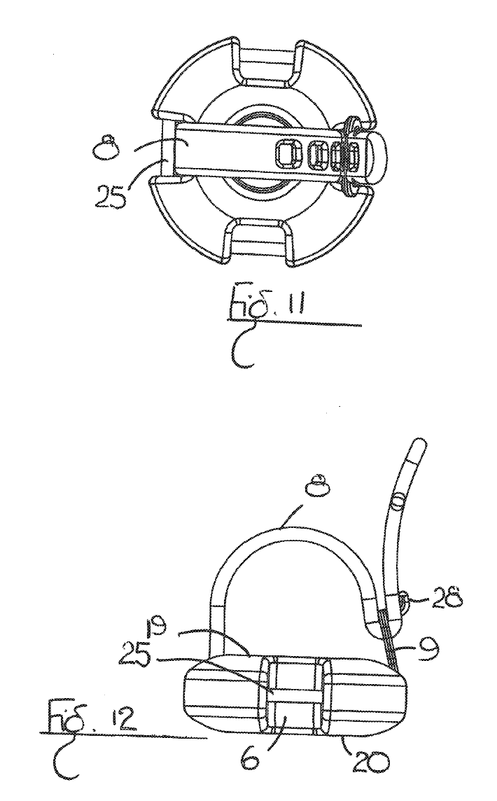

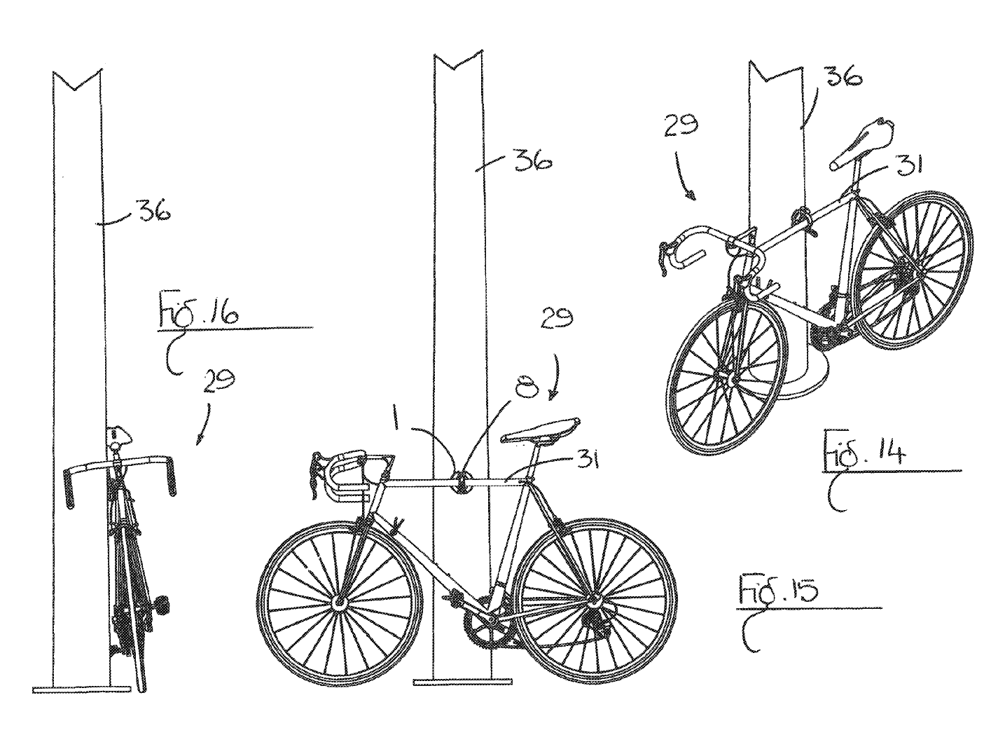

FIGS. 8 to 16 show a second embodiment of the spacer 1 of the invention broadly similar to the spacer 1 described in FIGS. 1 to 7. Like numerals indicate like parts. However, in the present embodiment, the engagement means 5 in the form of the stud 7 is omitted. However, the body 18 of the spacer 1 is generally circular in shape when viewed in plan and is provided with a central bore 23 while the slots 6 of the first embodiment described above are provided in the form of four peripheral indents 24 evenly spaced apart about the periphery of the circular body 18. Each indent 24 is provided with a transverse bar 25 towards the outer edge of each indent 24 so that the slots 6 are defined between the bars 25 and the spacer body 18.

In the present embodiment, the top wall 19, bottom wall 20 and side wall 21 of the spacer body 18 are bevelled or chamfered to eliminate potentially damaging sharp edges from the spacer 1.

The strap 8 of the present embodiment is broadly similar in construction to the strap 8 previously described. However, the strap hook 9 is provided with a hook latch 26 at its free end for attaching the hook 9 to the transverse bar 25 while the hook 9 is provided with a strap opening 27 at its other end to receive the strap second end 14 in a belt-like or buckle-like manner. A strap grip 28 is also provided adjacent the strap opening 27 to catch or grip the strap 8 at the strap apertures 15. The strap 8 is provided with a stop 10 at its other end 12 as previously described to prevent the strap 8 from passing through the slots 6 at its other end 12 so that the strap 8 can be secured between two oppositely disposed slots 6 about articles 2,3.

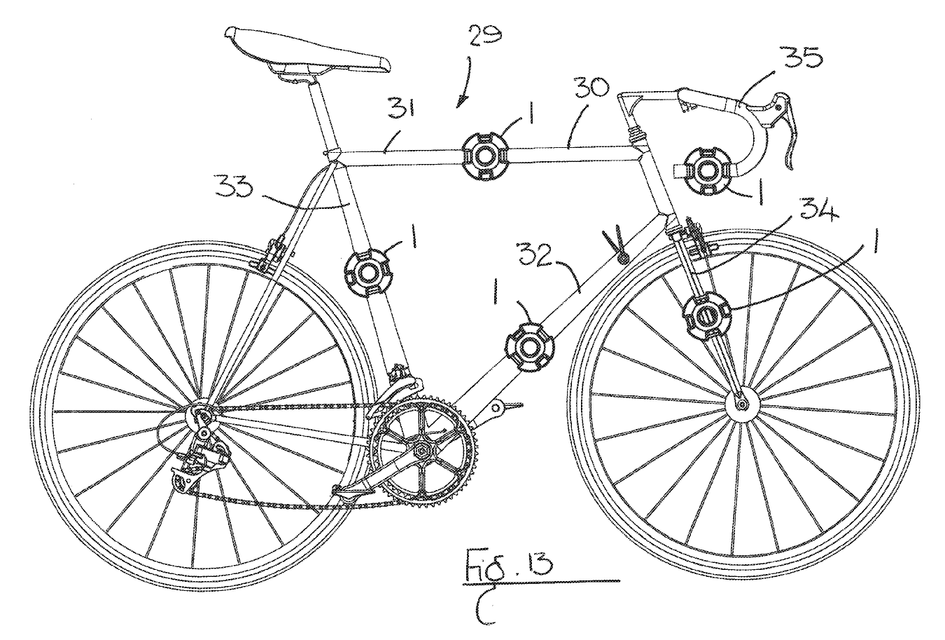

In use, as shown in FIGS. 13 to 16, single or multiple spacers 1 of FIGS. 8 to 12 can be fitted to a bicycle 29 to protect the bicycle 29 from damage by spacing the bicycle 29 away from potentially damaging articles or structures. For example, as shown in FIG. 13, multiple spacers 1 can be secured as via the straps 8 to a bicycle frame 30, top tube 31, down tube 32, seat tube 33, fork 34 and handlebar 35 as required in order to protect these articles from damage as required. As shown in FIGS. 14 to 16, even a single spacer 1 secured via a strap to the top tube 31 of the bicycle 29 is sufficient to protect the bicycle frame 31 from damage by an adjacent column 36 against which the bicycle 29 is placed.

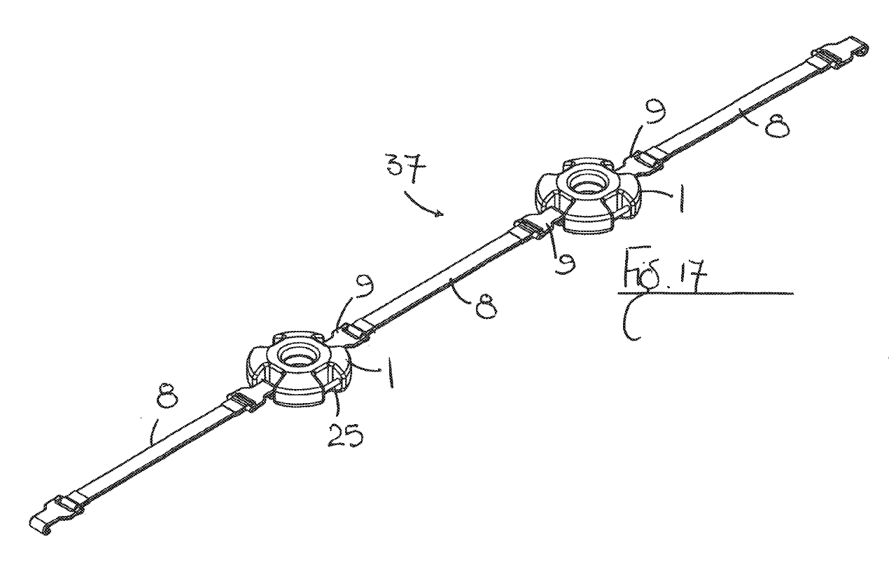

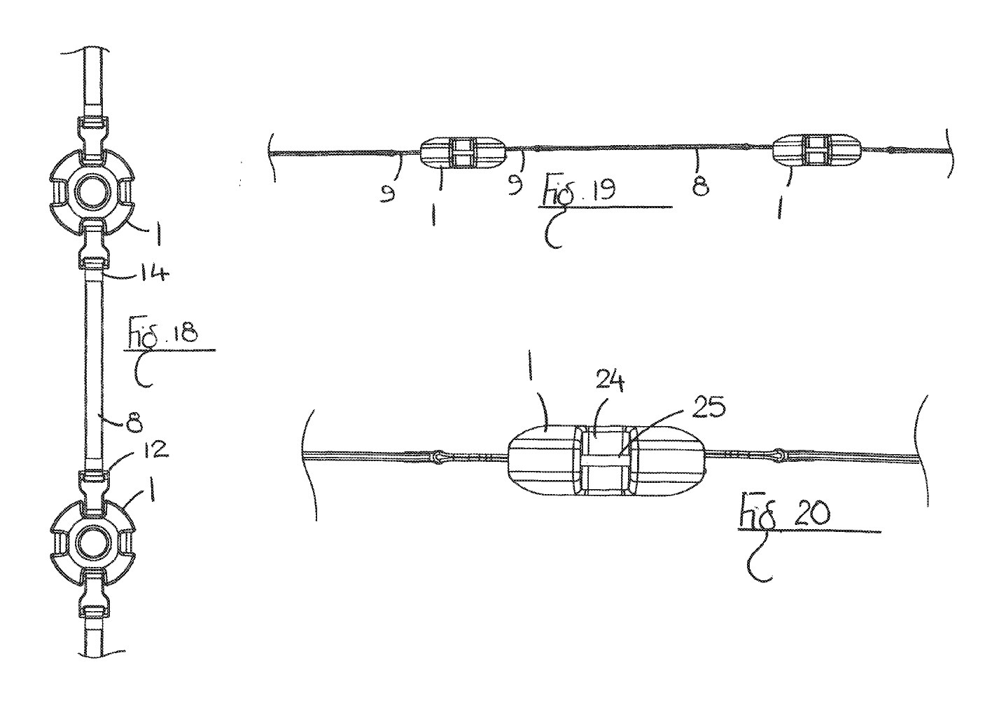

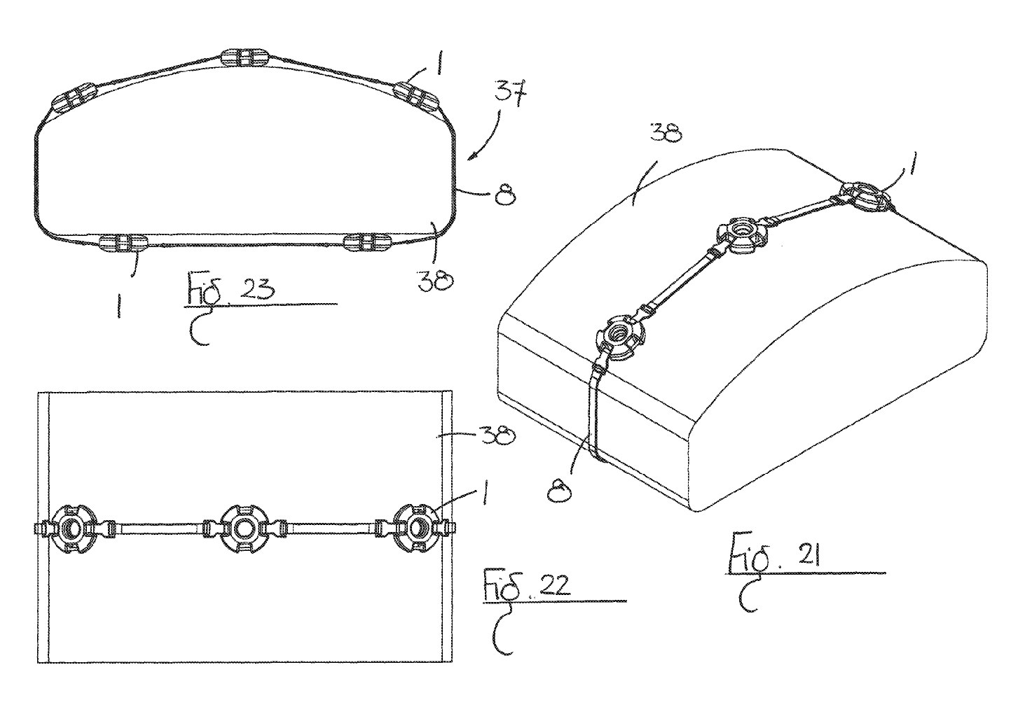

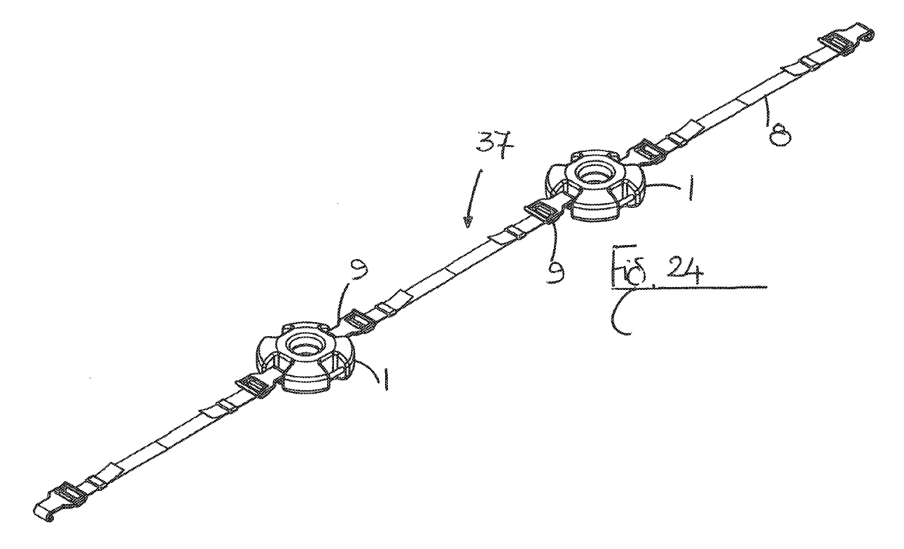

FIGS. 17 to 23 show a second embodiment of a spacer system 37 of the invention made up of a plurality of the spacers 1 of FIGS. 8 to 16 interconnected by elasticated straps 8 with hooks 9 at each end 12,14 of the straps 8. Accordingly, each strap 8 in the system 37 is adapted to be secured to the indent bar 25 of a slot 6 of the spacer 1 via the hook 9 at each end 12,14 the strap 8. The length of the spacer system 37 can be increased or decreased as required in accordance with the number of spacers 1 and straps 8 linked in the system 37. The spacer system 37 is particularly suitable for use in protecting items to be transported such as cases 38 (see FIGS. 21 to 23). Due to the elasticated nature of the straps 8 of the present embodiment, the spacer system 37 is adapted for use with items having irregular shapes and sizes such as the case 38 which has curved and flat surfaces.

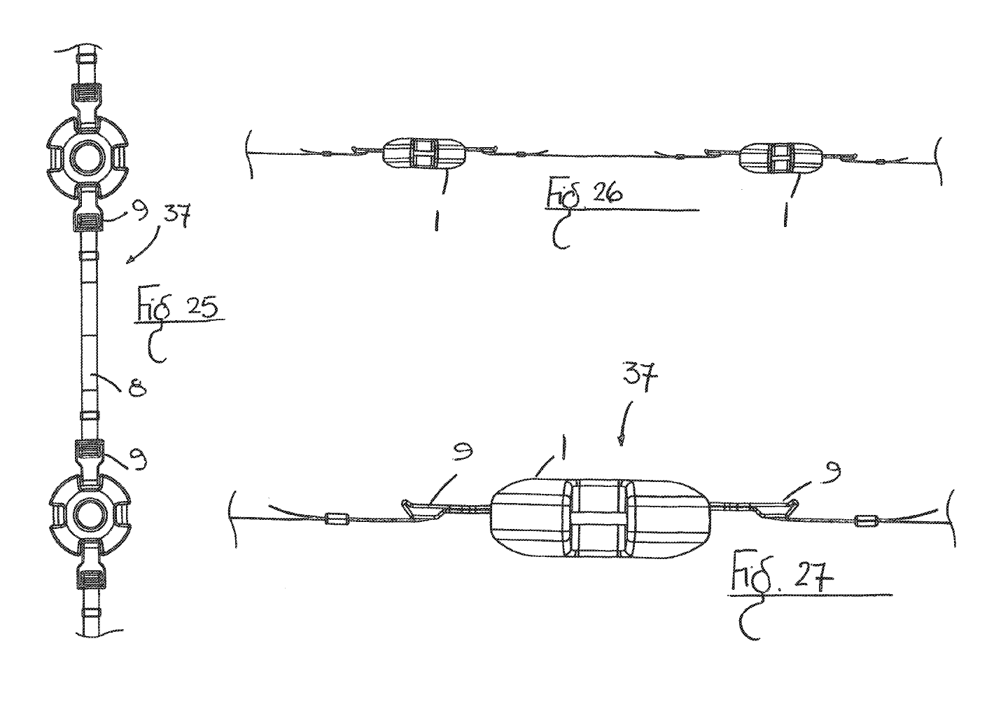

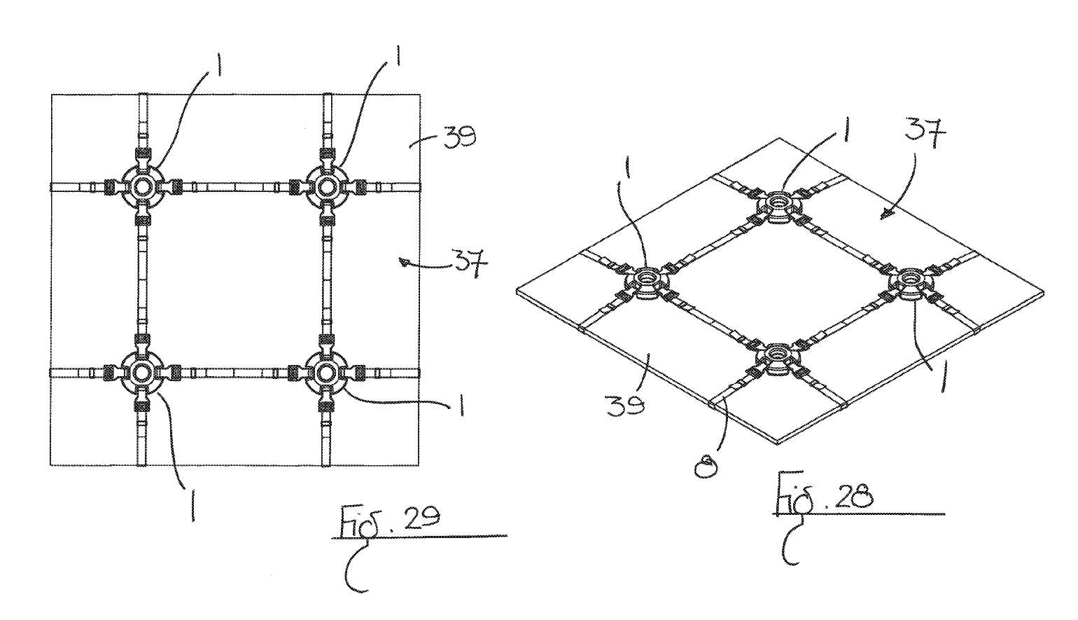

FIGS. 24 to 29 show a third embodiment of the spacer system 37 of the invention made up of a plurality of the spacers 1 of FIG. 8 interconnected by length adjustable straps 8 with hooks 9. The spacer system 37 of the present embodiment is broadly similar to the spacer system 37 of FIGS. 17 to 23 and like numerals indicate like parts. However, in the present embodiment, the elasticated strap 8 of FIGS. 17 to 23 is replaced by a length adjustable strap 8 having hooks 9 at each end 12,14 thereof which can be attached to the indent bars 25 of the slots 6 of the spacers 1 as previously described. Accordingly, the spacing of spacers 1 in the spacer system 37 can be adjusted as required.

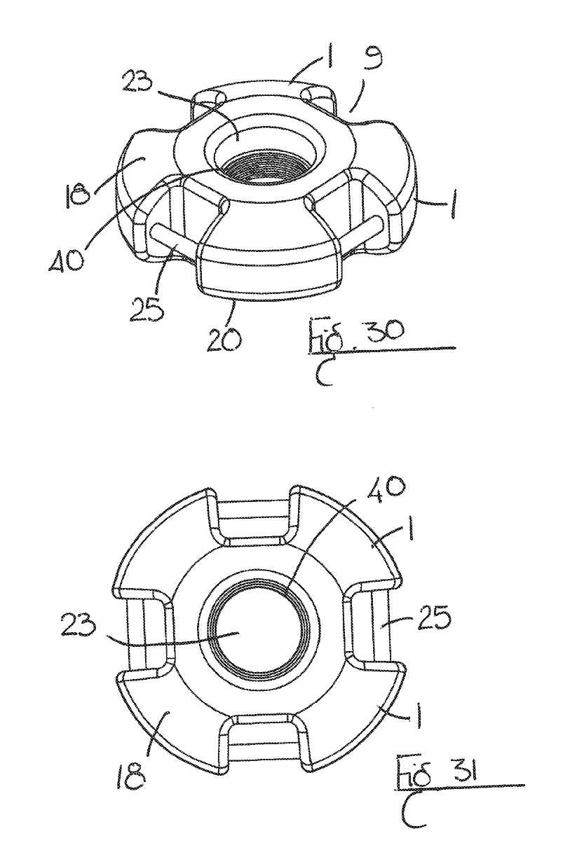

As shown in FIGS. 28 and 29, straps 8 can be attached via the hooks 9 to each of the four indent bars 25 of the four slots 6 of the spacer 1 to create a network-like or web-like spacer system 37 suitable for protecting articles from damage as required. For example, the spacer system 37 can be fitted to a flat package, e.g. a glass panel 39, to space the panel 39 apart from and protect the panel 39 from damage by other articles or surfaces.

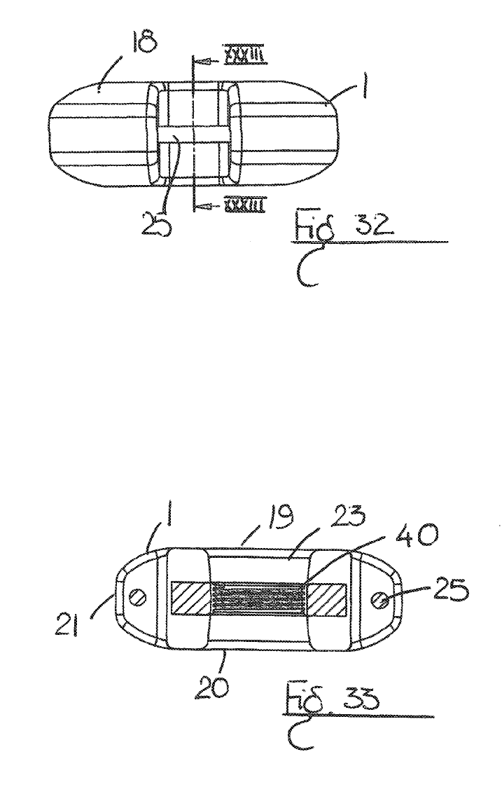

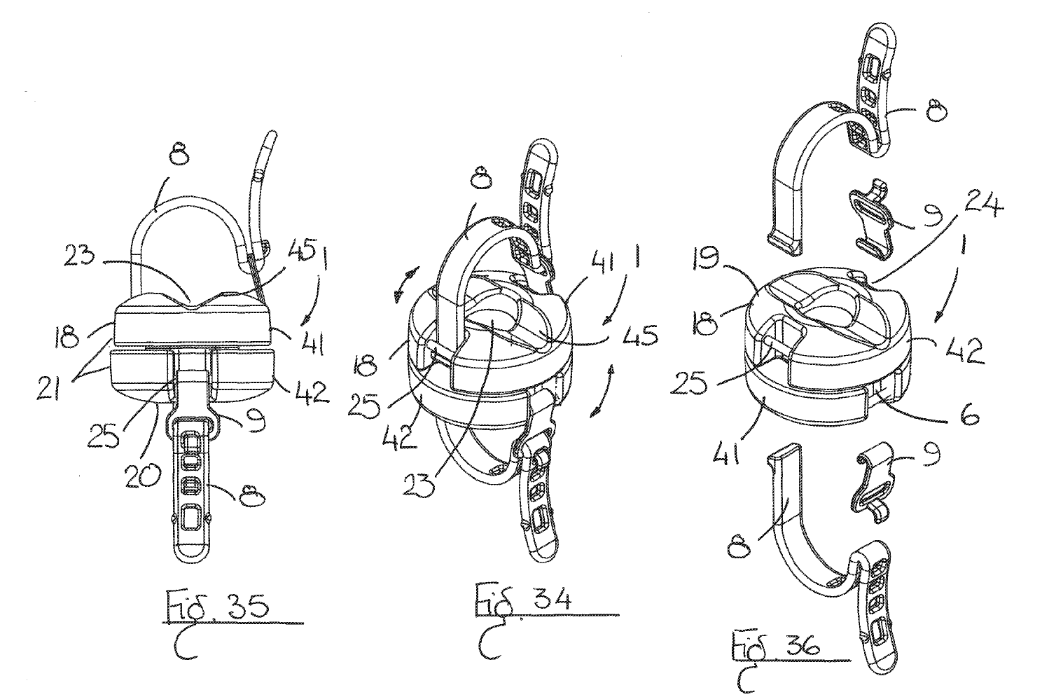

FIGS. 30 to 33 show a third embodiment of the spacer 1 of the invention similar to the spacer 1 of FIGS. 8 to 29. However, in the present embodiment, the spacer 1 is provided with a centrally located fastener in the form of an internal thread 40 in the central bore 23 of the body 18 of the spacer 1 for fastening and holding accessories on the spacer 1 via complimentary threads on the accessories. Examples of accessories that can be fastened to the spacer 1 include lights and threaded links to fasten multiple spacers 1 together e.g. a first spacer 1 to a second spacer 1 as previously described in FIG. 5.

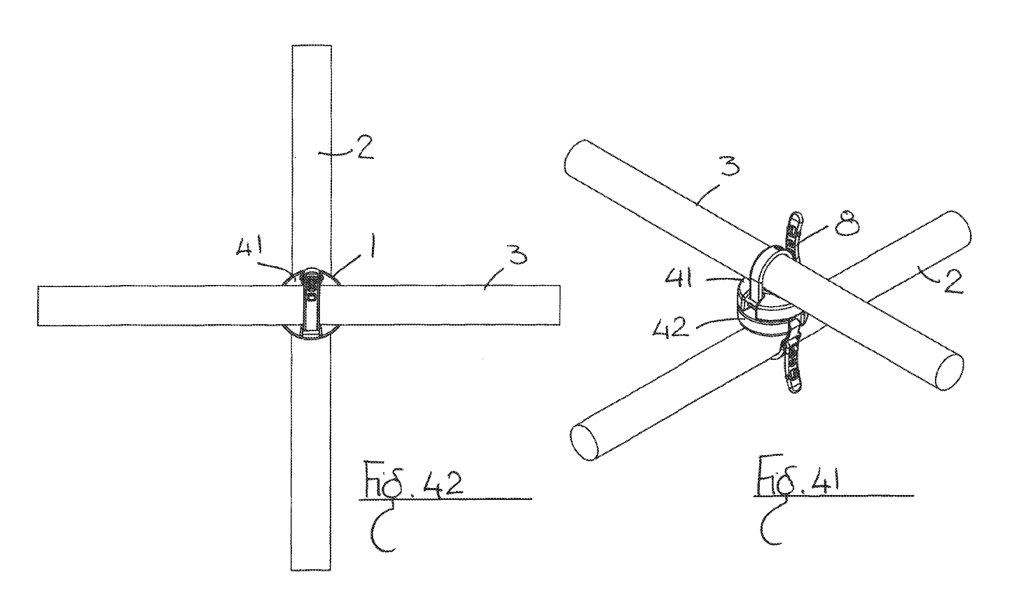

FIGS. 34 to 42 show a perspective view from above and one side of a fourth embodiment of a spacer 1 of the invention broadly similar to the spacer 1 of FIGS. 1 to 33 in which the spacer 1 is a rotatable spacer 1 made up of a two-part body 18 in which the two parts are rotatable with respect to each other in the directions indicated by the arrows to allow transverse positioning of elongate articles 2,3 between which the spacer 1 is secured. Like numerals indicate like parts.

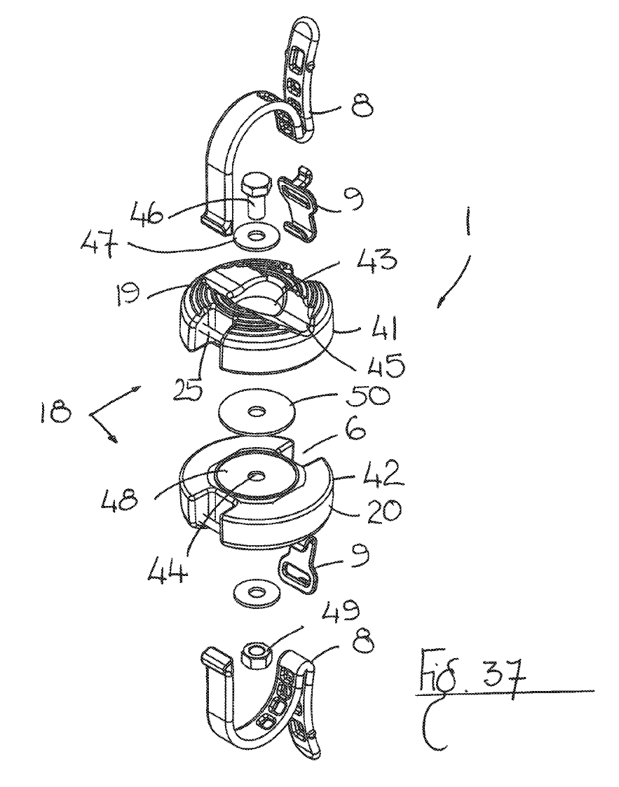

As shown particularly in FIGS. 35 to 38, the body 18 of the rotatable spacer 1 of the present embodiment is made up of a rotatable body top 41 and a rotatable body bottom 42 rotatably attached to the rotatable body top 41. Each of the rotatable body top 41 and the rotatable body bottom 42 are securable to articles 2,3 via straps 8. Moreover, the rotatable body top 41 and the rotatable body bottom 42 are both independently rotatable so that the angles of two articles 2,3 to which each of the respective rotatable body top 41 and the rotatable body bottom 42 are separately secured via straps 8 are independently adjustable with respect to each other to enable positioning of the articles 2,3.

The central bore 23 of the spacer body 18 is defined by a top bore portion 43 defined in the rotatable body top 41 and a contiguous bottom bore portion 44 defined in the rotatable body bottom 42. Each of the rotatable body top 41 and the rotatable body bottom 42 is provided with two oppositely disposed slots 6 in the form of indents 24 with peripheral indent bars 25 as previously described so that each spacer 1 has four slots 6 in total as previously described. However, as each pair of slots 6 is provided on each of the rotatable body top 41 and rotatable body bottom 42, the pairs of slots 6 are rotatable with respect to each other.

The rotatable body top 41 defines the chamfered spacer top wall 19 while the rotatable body bottom 42 defines the chamfered spacer bottom wall 20 and the rotatable body top 41 and rotatable body bottom 42 in combination define the chamfered spacer sidewall 21. However, in the present embodiment, the spacer top wall 19 and the spacer bottom wall 20 are shaped to define an elongate generally V-shaped in cross-section recess 45 for receiving elongate profiled articles 2,3 (e.g. tubular shaped articles) which can be held in place in the recesses 45 by the straps 8 and hooks 9 as previously described.

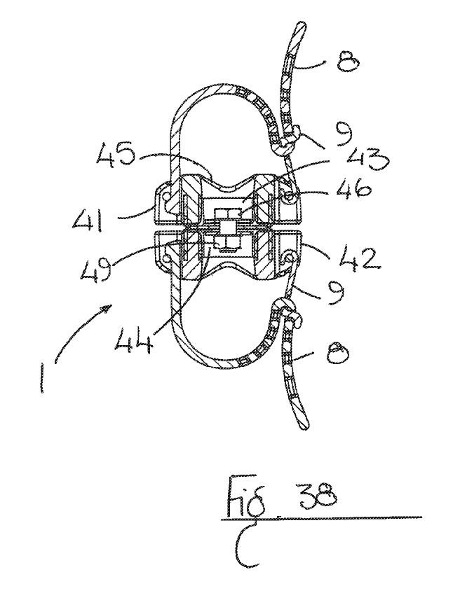

As shown in FIGS. 37 and 38, the rotatable body top 41 and rotatable body bottom 42 are rotatably attached via a rotatable mechanism in the form of a link bolt 46 extending between the top bore portion 43 and the bottom bore portion 44 of the central bore 23. The link bolt 46 is held in place by a top bearing 47 in the rotatable body top 41 and a corresponding bottom bearing 48 in the rotatable body bottom 42 while a and bottom nut 49 in the body bottom 42 holds the link bolt 46 in place in the spacer body 18. The rotatable mechanism is further supported between the rotatable body top 41 and the rotatable body bottom 42 by a central bearing 50 located between the rotatable body top 41 and the rotatable body bottom 42.

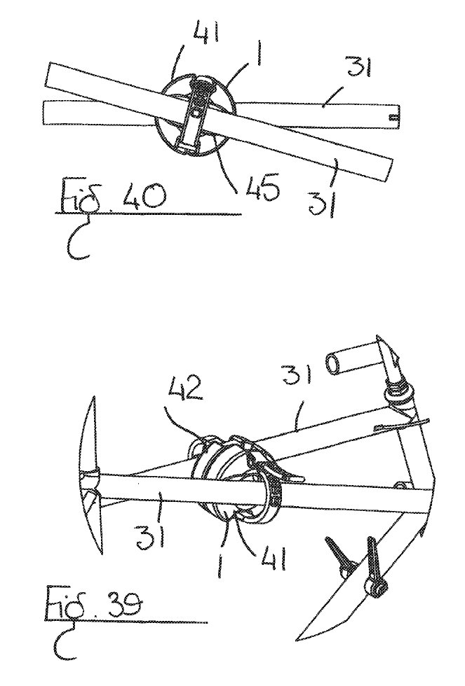

FIGS. 39 to 42 show the two-part rotatable spacer 1 of the present embodiment in use mounted between the top tubes 31 of two bicycle frames 30 to keep the bicycle frames 30 apart during transport and/or storage with the top tubes 31 in a transverse orientation with respect to each other. More particularly, each of the rotatable body top 41 and bottom 42 is secured to a bicycle top tube 31 by straps 8 and is held in place in the recesses 45 present on each of the rotatable body top 41 and bottom 42. The position of each of the top tubes 31 can be pivoted with respect to each other by simply rotating the rotatable body top 41 and bottom 42 as required to minimise contact of the bicycle frames 30 and other structures to avoid damage to the bicycle 29.

The spacer block 1, spacer block system and kit of the invention is not limited to the mounting of a bicycle onto or against a rack and the spacer block 1 and the spacer block system and kit described herein are suitable for maintaining a gap between any articles 2,3 where such a gap is necessary or desired.

As indicated above, the spacers 1 of the invention can be manufactured from any suitable materials that will minimise or prevent damage to articles. Resilient, soft or cushioning materials are preferred such as rubbers, silicones and plastics although other materials could be used provided the spacer 1 was finished or covered (e.g. an overmould) in a non-damaging material.

1. A spacer for spacing apart articles comprising:
a spacer body, and
engaging means on the spacer body for reversibly attaching the spacer to a first article to prevent impact with a second article.

2. A spacer as claimed in claim 1 wherein the engaging means is reversibly attachable to the first and second articles.

3. A spacer as claimed in claim 1 wherein the engaging means comprises selectable engaging means to orientate the spacer on the article.

4. A spacer as claimed in claim 1 wherein the spacer body comprises a solid spacer body.

5. A spacer as claimed in claim 1 wherein the spacer body comprises a rotatable spacer body.

6. A spacer as claimed in claim 5 wherein the rotatable spacer body comprises a two-part rotatable body and the first part is rotatable with respect to the second part.

7. A spacer as claimed in claim 1 wherein the spacer body comprises a central bore.

8. A spacer as claimed in claim 7 wherein the central bore comprises a threaded central bore.

9. A spacer as claimed in claim 1 wherein the engaging means comprises a slot on the spacer body.

10. A spacer as claimed in claim 9 wherein the slot comprises a peripheral slot on the spacer body.

11. A spacer as claimed in claim 9 wherein the slot comprises an indent.

12. A spacer as claimed in claim 9 wherein the slot comprises a bar on the spacer body.

13. A spacer as claimed in claim 1 wherein the engaging means comprises a stud on the spacer body.

14. A spacer as claimed in claim 13 wherein the stud comprises a peripheral stud on the spacer body.

15. A spacer as claimed in claim 1 wherein the spacer comprises at least two opposite engaging means.

16. A spacer as claimed in claim 1 wherein the spacer comprises at least four engaging means.

17. A spacer as claimed in claim 1 wherein the spacer comprises at least six engaging means.

18. A spacer as claimed in claim 1 further comprising a securing means for securing the engaging means to an article.

19. A spacer as claimed in claim 18 wherein the securing means comprises a strap.

20. A spacer as claimed in claim 19 wherein the strap comprises an adjustable strap.

21. A spacer as claimed in claim 20 wherein the adjustable strap comprises an elasticated strap.

22. A spacer as claimed in claim 19 wherein the strap comprises a belt-like strap.

23. A spacer as claimed in claim 1 wherein the spacer comprises a bicycle spacer.

24. (canceled)

25. A spacer system comprising at least two spacers as claimed in claim 1.
